(19) United States
(12) Patent Application Publication
(10) Pub. No.: US 2006/0055687 A1
(43) Pub. Date: Mar. 16, 2006

(54) Brightness control circuits

(75) Inventors: Shyh-Shyuan Sheu, Taichung (TW); Lieh-Chiu Lin, Kaohsiung (TW); Ming-Daw Chen, Hsinchu (TW); Jan-Ruei Lin, Taipei (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/056,173

(22) Filed: Feb. 14, 2005

(30) Foreign Application Priority Data
Sep. 15, 2004 (TW) 93127845

(51) Int. Cl. G09G 5/00

(52) U.S. Cl. 345/204

(57) ABSTRACT

Brightness control circuits and drivers and display devices using the same. In the brightness control circuit, a current digital-to-analog converter (DAC) receives a digital code and generates a control current, and an one-shot circuit is coupled to the current DAC to generate a pulse width modulated (PWM) signal according to the control current and a clock signal. The digital code and pulse width modulated signal have an exponential relationship.

### BACKGROUND

The invention relates to control circuits, and more particularly, to brightness control circuits employed in display devices.

FIG. 1 shows a conventional brightness control circuit in a data driver of a display device. The brightness control circuit 10 includes a sample and hold circuit 55, a discharge circuit 70 and a comparator 75. The analog voltage signal Va from external digital-to-analog converter (not shown) is stored in the storage capacitor 90 by the sample and hold circuit 55. The voltage stored in the storage capacitor 90 is discharged with a constant proportion by the current source 72 in the discharge circuit 70. The pulse width modulated signal PWM_out is obtained according to the reference voltage VT and the voltage stored in the storage capacitor 90 by the comparator 75.

However, complexity and occupied area of the entire driver are increased due to the brightness control circuit 10 at least requiring the sample and hold circuit 55, the current source 72 and the comparator 75. Further, the brightness control circuit 10 has a slower operating speed, and thus, is not suitable for large size and high resolution display devices. Furthermore, the pulse width modulated signal of the control circuit 10 is not precise due to charge sharing and clock feedthrough in the sample and hold circuit 55.

### SUMMARY

In a brightness control circuit, a current digital-to-analog converter (DAC) receives a digital code and generates a control current, and a one-shot circuit is coupled to the current DAC to generate a pulse width modulated (PWM) signal according to the control current and a clock signal. The digital code and pulse width modulated signal have an exponential relationship.

In an embodiment of a brightness control circuit, the one-shot circuit includes a delay circuit coupled to the current DAC, delaying the clock signal for a predetermined time interval and outputting a delayed clock signal according to the control current; and a logic gate unit coupled to the delay unit, generating the pulse width modulated signal according to the clock signal and the delayed clock signal. The pulse width of the pulse width modulated signal depends on the predetermined time interval.

### DESCRIPTION OF THE DRAWINGS

The invention can be more fully understood by the subsequent detailed description and examples with reference made to the accompanying drawings, wherein:

FIG. 1 shows a conventional brightness control circuit in a data driver of a display device;

FIG. 2A is a diagram of a brightness control circuit;

FIG. 2B is another diagram of a brightness control circuit

FIG. 3A is a first exemplary embodiment of a brightness control circuit;

FIG. 3B is a second exemplary embodiment of a brightness control circuit;

FIG. 3C is a third exemplary embodiment of a brightness control circuit;

FIG. 3D is a fourth exemplary embodiment of a brightness control circuit;

FIGS. 4A˜4C show different wave diagrams of brightness control circuit with different digital codes according to the first embodiment;

FIG. 5A shows an inverse proportion between a digital value represented by a digital code and the pulse width;

FIG. 5B shows a direct proportion between a digital value represented by a digital code and the pulse width;

FIG. 6 shows a non-linear relationship between the pulse width PW and the brightness;

FIG. 7 shows an exponential relationship between the digital value and the pulse width;

FIG. 8 shows a linear relationship between the pulse width and the brightness;

FIG. 9 is an exemplary embodiment of a display device;

FIGS. 10A˜10C show different wave diagrams of a brightness control circuit with different digital codes according to the second embodiment; and

FIGS. 11A˜11C show different wave diagrams of brightness control circuit with different digital codes according to the fourth embodiment.

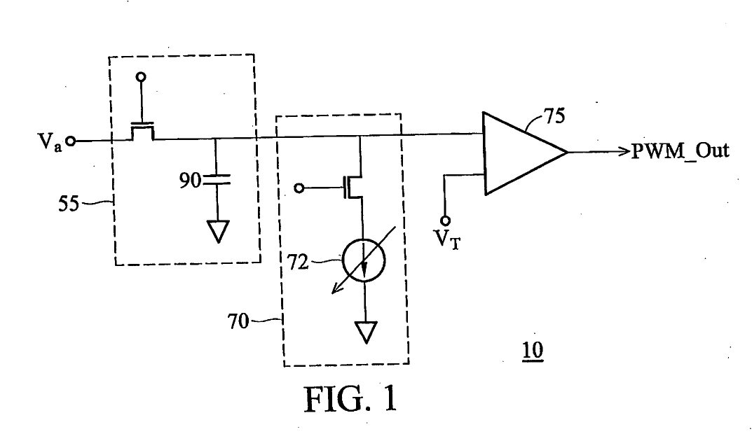

### DETAILED DESCRIPTION

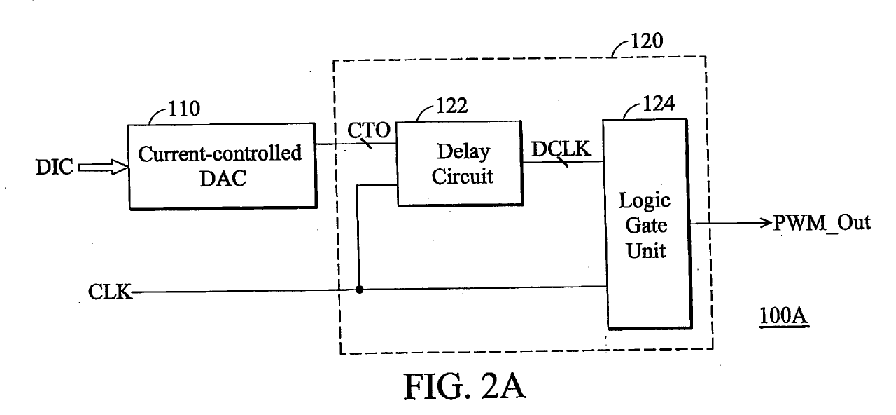

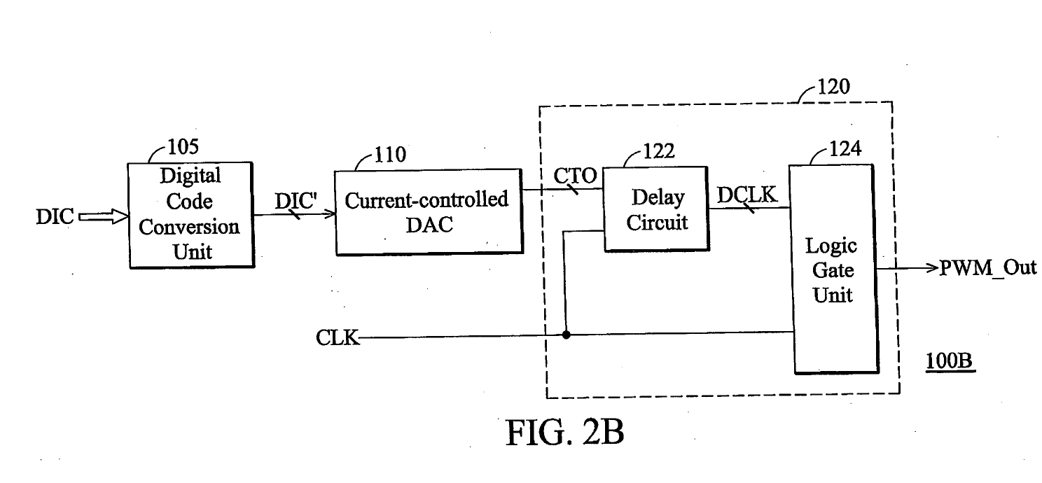

FIG. 2A is a diagram of a brightness control circuit. The brightness control circuit 100 comprises a current digital-to-analog converter (DAC) 110 and a one-shot circuit 120. The current DAC 110 receives a digital code DIC from an external time controller (not shown), converts the received digital code to a corresponding output current CTO as a control current, and outputs to the one-shot circuit 120. Namely, the current DAC 110 can output different currents CTO according to different digital codes DIC.

For example, the one-shot circuit can be a pulse width modulator, and can comprise a delay circuit 122 and a logic gate unit 124. The delay circuit 122 receives the output current CTO from the current DAC 110 and an external clock signal CLK, delays the clock signal CLK for a predetermined time interval according to the output current CTO, and outputs a delayed clock signal DCLK (delay signal). Namely, the delay circuit 122 generates different time delays between the clock signal CLK and the delayed signal DCLK according to different output currents CTO. The logic gate unit 124 receives the clock signal CLK and the delayed signal DCLK and generates a pulse width modulated signal PWM_out to output to a corresponding pixel of a display device, thereby controlling brightness. Namely, the logic gate unit 124 generates pulse width modulated signal PWM_out with different pulse widths according to different time delays between the clock signal CLK and the delayed signal DCLK.

### First Embodiment

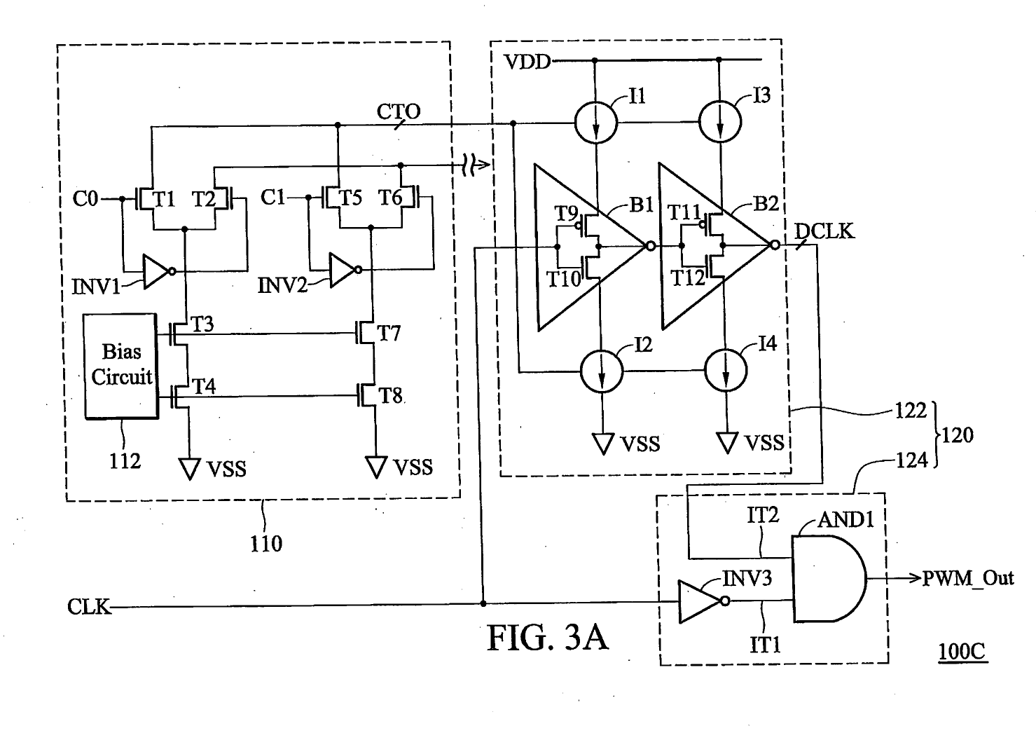

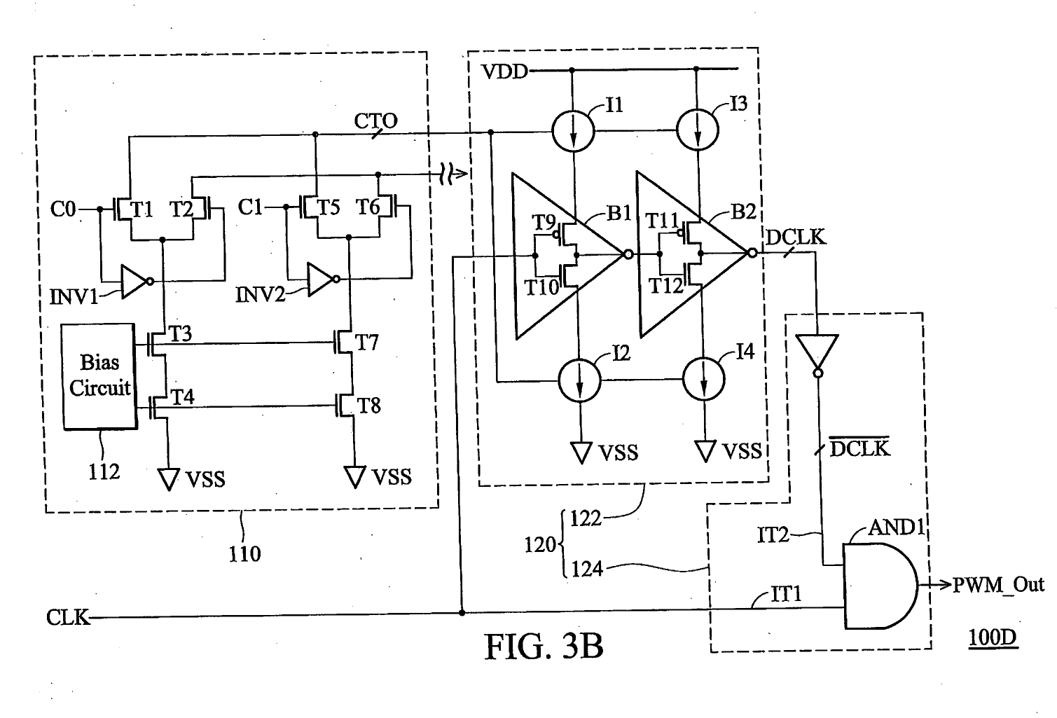

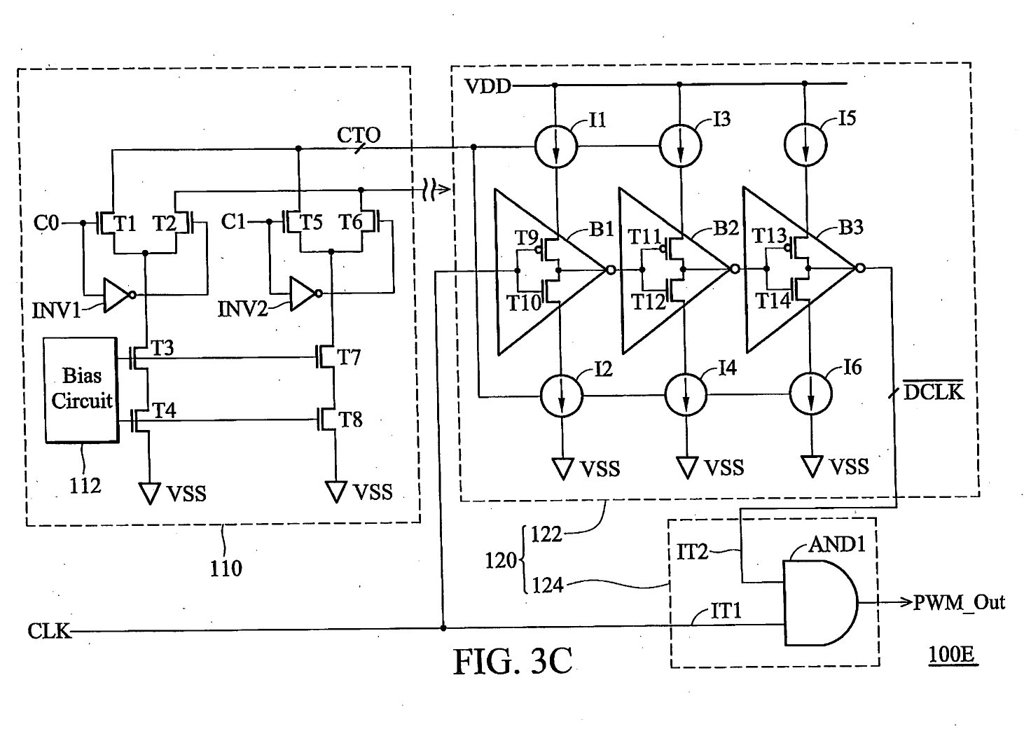

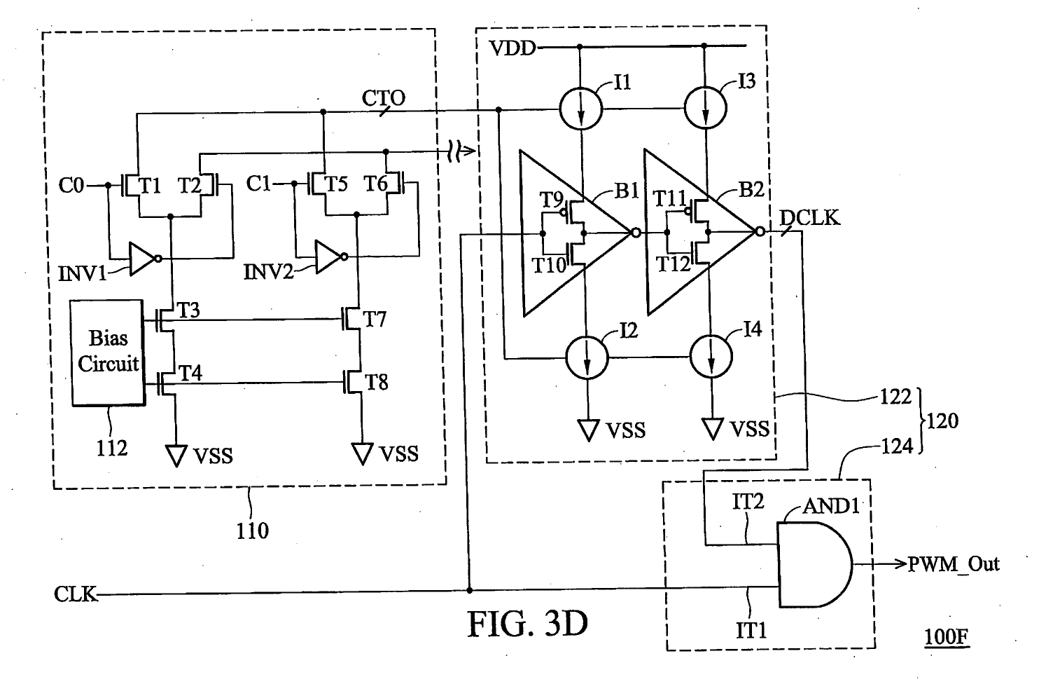

FIG. 3A is a first exemplary embodiment of a brightness control circuit. As shown, the current DAC 110 comprises first and second differential pairs and a bias circuit 112, receiving a digital code DIC (C1, C0) from an external time controller (not shown) and outputting a corresponding output current CTO. The first differential pair is composed of the transistors T1-T4 and the inverter INV1, and the second differential pair is composed of the transistors T5-T8 and the inverter INV2. The bias circuit 112 biases the transistors T3, T4, T7 and T8, such that the output current CTO from the current DAC 110 is not interfered with the ground terminal VSS. In this embodiment, the current of the second differential pair is two times that of the first differential pair, but it is to be understood that the invention is not limited thereto. The invention can also utilize N differential pairs to receive and convert the digital code DIC to a corresponding output current CTO.

The delay circuit 122 comprises four current-controlled current sources I1˜I4 and two delay stages D1 and D2, delaying the clock signal CLK for a predetermined time interval according to the output current CTO and outputting a delayed signal DCLK (delayed clock signal). The delay stage D1 comprises transistors T9 and T10 and has an input terminal coupled to the clock signal CLK, and the delay stage D2 comprises transistors T11 and T12, an input terminal coupled to the output terminal of the delay stage D1 and an output terminal outputting the delayed signal DCLK. The current-controlled current source 11 is coupled between the power terminal VDD and the source terminal of the transistor T9, and the current-controlled current source 12 is coupled between the power terminal VDD and the source terminal of the transistor T10. The current-controlled current source 13 is coupled between the power terminal VDD and the source terminal of the transistor T11, and the current-controlled current source 14 is coupled between the power terminal VDD and the source terminal of the transistor T12. The control terminals of the current-controlled current source I1˜I4 are coupled to the output current CTO from the current DAC 110. The current-controlled current sources I1˜I4 charges/discharges the delay stages D1 and D2 according to the output current CTO, thereby controlling the delay stage D2 to output the delayed clock signal DCLK. Thus, there is a time delay between the clock signal CLK and the delayed clock signal DCLK (delay signal).

The logic gate unit 124 comprises an inverter INV3 and a AND gate AND1, generating a corresponding pulse width modulated signal PWN_out according to the clock signal CLK and the delayed clock signal DCLK. The clock signal CLK is coupled to the input terminal IT1 of the AND gate AND1 and the delayed clock signal DCLK is coupled to the other input terminal IT2 of the AND gate AND1. Due to the time delay between the clock signals CLK and DCLK, the AND gate AND1 generates a pulse width modulated signal PWM_out to a corresponding pixel of a display device thereby controlling brightness. In this embodiment, the pulse width of the pulse width modulated signal PWM_out is determined by the time delay between the clock signal CLK from an external timing controller and the delayed clock signal DCLK from the delay circuit 122.

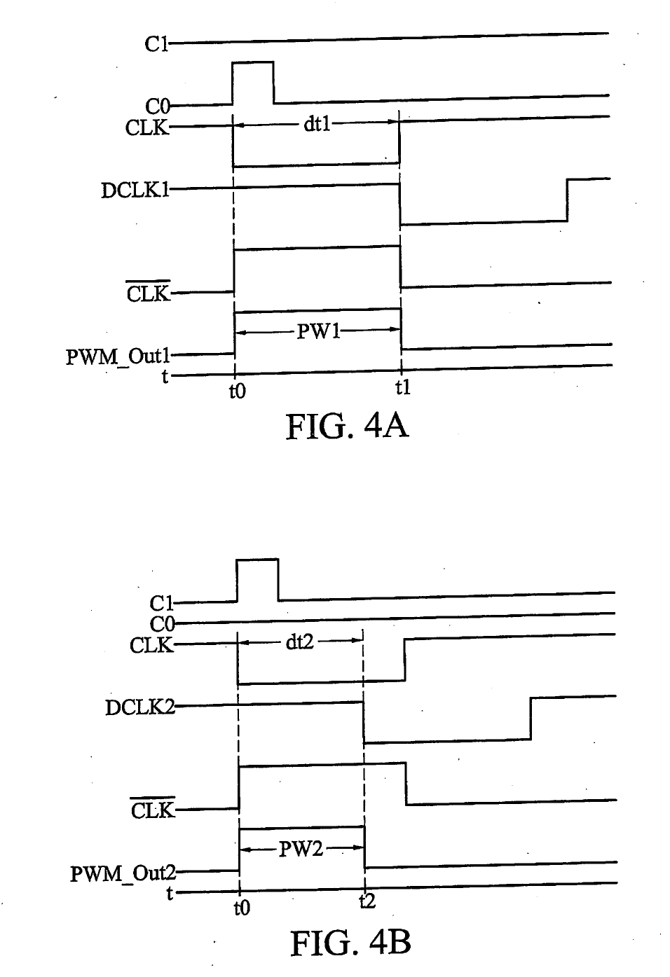

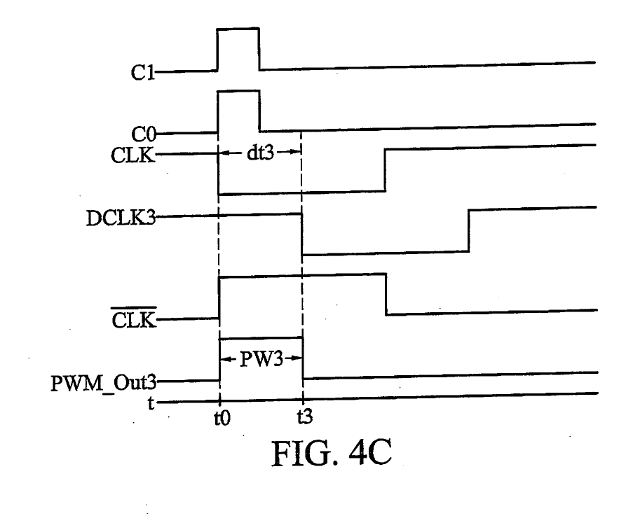

FIGS. 4A˜4C show different wave diagrams of brightness control circuits with different digital codes. FIG. 4A shows a wave diagram of brightness control circuit in which the digital code (C1, C0) is “01”. FIG. 4B shows a wave diagram of brightness control circuit in which the digital code (C1, C0) is “10”. FIG. 4C shows a wave diagram of brightness control circuit in which the digital code (C1, C0) is “11”. The current DAC 110 generates different output current CTO according to different digital codes (C1 and C0), and the delay circuit 122 delays the clock signal CLK for different time interval according to the different output current CTO.

For example, the current DAC 110 generates the output currents CTO_01, CTO_10 and CTO_11 when the digital code (C1, C0) is “01”, “10 and “11” respectively. In this embodiment, CTO_01<CTO_10<CTO_11, larger output current CTO and the time delay between the clock signal CLK and the delayed clock signal DCLK is smaller. Namely, the delay circuit 122 outputs the delayed clock signal DCLK with the larger output current CTO more rapidly. As shown in FIGS. 4A˜4C, the delay circuit 122 delays the clock signal CLK for time intervals dt1, dt2 and dt3 respectively, according to the output currents CTO_01, CTO_10 and CTO_11. The delay time intervals are dt1>dt2>dt3 because the output currents are CTO_01<CTO_10<CTO_11.

If the clock signal CLK is high before time t0, the input terminals IT1 and IT2 of the AND gate AND1 are at low and high levels respectively, such that the output terminal of the AND gate AND1 is maintained at a low level. The clock signal CLK goes low when time is t1, the input terminal IT1 is at a high level. At this time, due to the delay circuit 122, the input terminal IT2 is still maintained at the high level, and thus, the output terminal of the AND gate AND1 is changed to a high level.

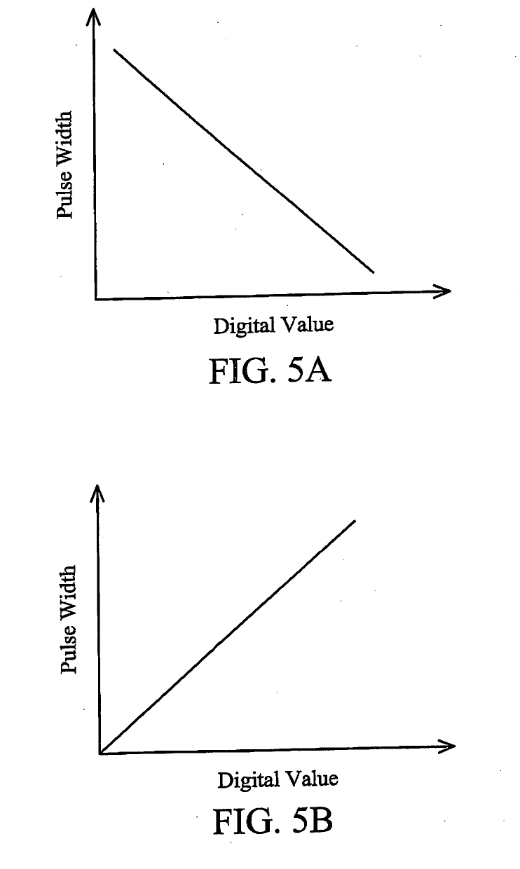

When the clock signal CLK is delayed for a time interval, such as time t1, t2 or t3, the delayed clock signal DCLK is output to the input terminal IT2, namely the input terminal IT2 is changed to a low level. At this time, the output terminal of the AND gate AND1 is changed to a low level accordingly. As shown in FIGS. 4A˜4C, pulse widths of the pulse width modulated signal PWM_out1˜PWM_out3 are essentially equal to the corresponding delay time intervals dt1, dt2 and dt3 respectively. Further, the current of the second differential pair (T5 and T6) can be designed to be two times that of the first differential pair (T1 and T2), such that delay time intervals dt1:dt2:dt3=1:2:3, and thus, the pulse widths PW3: PW2: PW1=1:2:3 can be obtained. Thus, there is an inverse proportion between a digital value DV represented by a digital code DIC and the pulse width PW, as shown in FIG. 5A. Namely, a large digital value DV represented by a digital code DIC and smaller pulse width PW.

### Second Embodiment

FIG. 3B is a second exemplary embodiment of a brightness control circuit. As shown, the brightness control circuit 100D is similar to the circuit 100C except that the inverter INV3 is connected between the output terminal of the delay circuit 122 and the input terminal IT2 rather than between the clock signal CLK and the input terminal IT1.

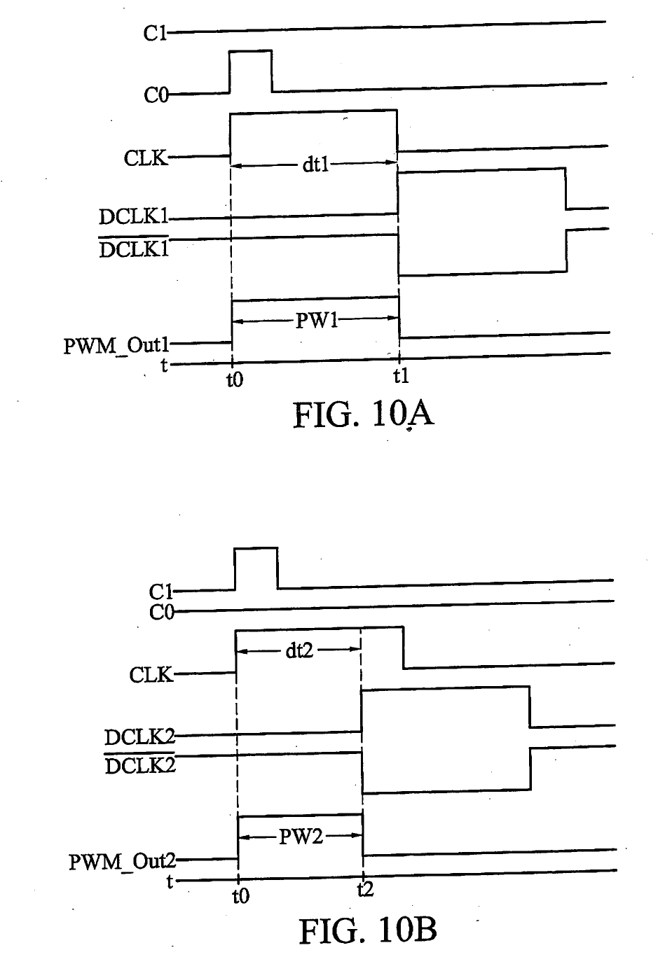

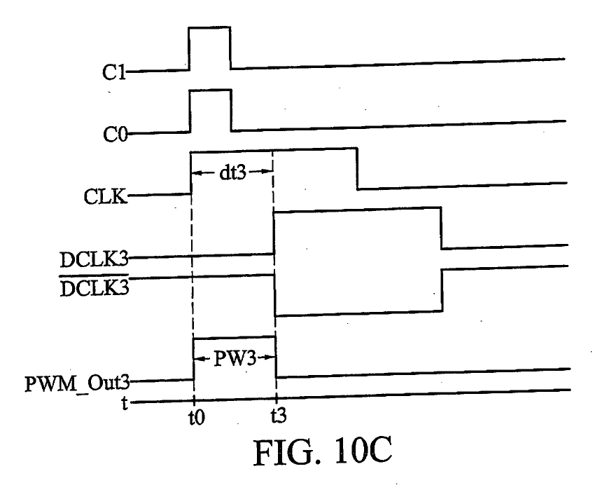

FIGS. 10A˜10C show different wave diagrams of brightness control circuit with different digital codes. FIG. 10A shows a wave diagram of brightness control circuit in which the digital code (C1, C0) is “01”. FIG. 10B shows a wave diagram of brightness control circuit in which the digital code (C1, C0) is “10”. FIG. 10C shows a wave diagram of a brightness control circuit in which the digital code (C1, C0) is “11”. The current DAC 110 generates different output currents CTO according to different digital codes (C1 and C0), and the delay circuit 122 delays the clock signal CLK for different time intervals according to the different output currents CTO.

For example, the current DAC 110 generates the output currents CTO_01, CTO_10 and CTO_11 when the digital code (C1, C0) is “01”, “10 and “11” respectively. In this embodiment, CTO_01<CTO_10<CTO_11, larger output current CTO and the time delay between the clock signal CLK and the delayed clock signal DCLK is smaller. Namely, the delay circuit 122 outputs the delayed clock signal DCLK with the larger output current CTO more rapidly. As shown in FIGS. 10A˜10C, the delay circuit 122 delays the clock signal CLK for time intervals dt1, dt2 and dt3 respectively, according to the output currents CTO_01, CTO_10 and CTO_11. The delay time intervals are dt1>dt2>dt3 because of output currents are CTO_01<CTO_10<CTO_11.

If the clock signal CLK is low before time t0, the input terminals IT1 and IT2 of the AND gate AND1 are at low and high levels respectively, such that the output terminal of the AND gate AND1 is maintained at a low level. The clock signal CLK goes high when time is t1, the input terminal IT1 is at a high level. At this time, due to the delay circuit 122, the input terminal IT2 is still maintained at the high level, and thus, the output terminal of the AND gate AND1 is changed to a high level.

When the clock signal CLK is delayed for a time interval, such as time t1, t2 or t3, the delayed clock signal DCLK is output to the input terminal IT2, namely the input terminal IT2 is changed to a low level. At this time, the output terminal of the AND gate AND1 is changed to a low level accordingly. As shown in FIGS. 10A˜10C, pulse widths of the pulse width modulated signal PWM_out1˜PWM_out3 are essentially equal to the corresponding delay time intervals dt1, dt2 and dt3 respectively. Further, the current of the second differential pair (T5 and T6) can be designed to be two times that of the first differential pair (T1 and T2), such that delay time intervals dt1:dt2:dt3=1:2:3, and thus, the pulse widths PW3:PW2:PW1=1:2:3 can be obtained. Thus, there is an inverse proportion between a digital value DV represented by a digital code DIC and the pulse width PW, as shown in FIG. 5A. Namely, a large digital value DV represented by a digital code DIC and smaller pulse width PW.

### Third Embodiment

FIG. 3C is a third exemplary embodiment of a brightness control circuit. As shown, the brightness control circuit 100E is similar to the circuits 100C and 100D shown in FIGS. 3A and 3B except that the logic gate unit 124 only comprise a AND gate AND1 without the inverter INV3 and the delay circuit 122 further comprise two current sources 15 and 16 and a delay stage D3. The delay stage D3 is coupled between the output terminal of the delay stage D2 and the input terminal IT2 of the AND gate AND1. The current-controlled current source 15 is coupled between the power terminal VDD and the source terminal of the transistor T13, The current-controlled current source 16 is coupled between the ground terminal VSS and the source terminal of the transistor T14, wherein the control terminals of the current sources 15 and 16 are coupled to the output current CTO of the current DAC 110. Similarly, the linear relationship shown in FIG. 5A can also be obtained by the brightness control circuit 100E and the operation thereof is similar to that of the circuits 100C and 100D, and description thereof is thus omitted for simplicity.

### Fourth Embodiment

FIG. 3D is a fourth exemplary embodiment of a brightness control circuit. As shown, the brightness control circuit 100F is similar to the circuit 100C shown in FIG. 3 except that the inverter INV3 connected between the clock signal CLK and the input terminal IT1 is omitted.

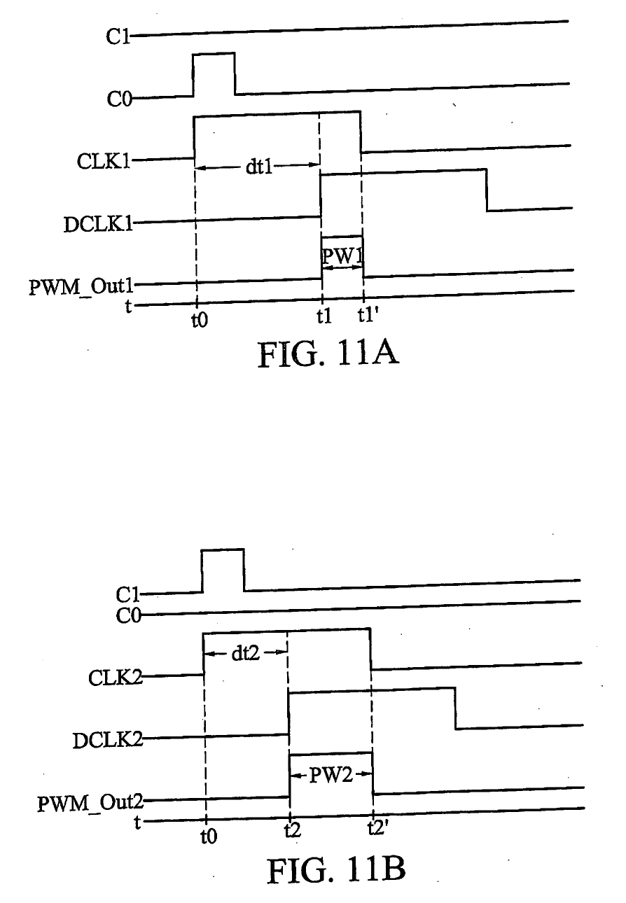

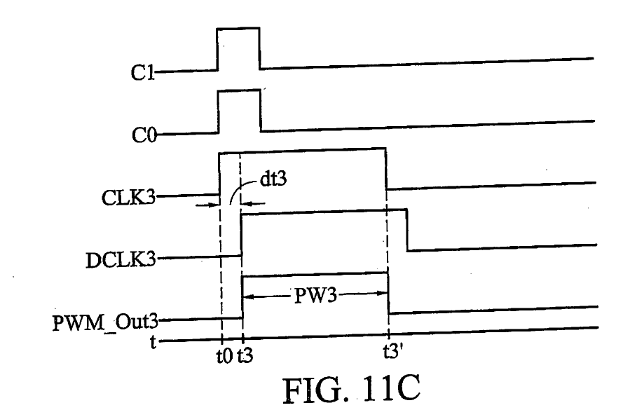

FIGS. 11A˜11C show different wave diagrams of brightness control circuit with different digital codes. FIG. 11A shows a wave diagram of brightness control circuit in which the digital code (C1, C0) is “01”. FIG. 11B shows a wave diagram of brightness control circuit in which the digital code (C1, C0) is “10”. FIG. 11C shows a wave diagram of brightness control circuit in which the digital code (C1, C0) is “11”. The current DAC 110 generates different output current CTO according to different digital codes (C1 and C0), and the delay circuit 122 delays the clock signal CLK for different time interval according to the different output current CTO.

For example, the current DAC 110 generates the output currents CTO_01, CTO_10 and CTO_11 when the digital code (C1, C0) is “01”, “10 and “11” respectively. In this embodiment, CTO_01<CTO_10<CTO_11, larger output current CTO and the time delay between the clock signal CLK and the delayed clock signal DCLK is smaller. Namely, the delay circuit 122 outputs the delayed clock signal DCLK with the larger output current CTO more rapidly. As shown in FIGS. 11A˜11C, the delay circuit 122 delays the clock signal CLK for time intervals dt1, dt2 and dt3 respectively, according to the output currents CTO_01, CTO_10 and CTO_11. The delay time intervals are dt1>dt2>dt3 because of output currents are CTO_01<CTO_10<CTO_11.

If the clock signal CLK is low before time t0, the input terminals IT1 and IT2 of the AND gate AND1 are at low level both, such that the output terminal of the AND gate AND1 is maintained at a low level. The clock signal CLK goes high when time is t1, the input terminal IT1 is at a high level. At this time, due to the delay circuit 122, the input terminal IT2 is still maintained at the low level, and thus, the output terminal of the AND gate AND1 is maintained at the low level also.

When the clock signal CLK is delayed for a time interval, such as time t1, t2 or t3, the delayed clock signal DCLK is output to the input terminal IT2, namely the input terminal IT2 is changed to a high level. At this time, the output terminal of the AND gate AND1 is changed to a high level accordingly. When the time is t1′, t2′ or t3′, the clock signal CLK goes low and the input terminal IT1 is changed to a low level. At this time, the output terminal of the AND gate AND1 is changed to a low level accordingly.

As shown in FIGS. 11A˜11C, pulse widths of the pulse width modulated signal PWM_outl_PWM_out3 are essentially equal to the corresponding delay time intervals dt1, dt2 and dt3 respectively. Further, the current of the second differential pair (T5 and T6) can be designed to be two times that of the first differential pair (T1 and T2), such that delay time intervals dt1:dt2:dt3=1:2:3, and thus, the pulse widths PW1:PW2:PW3=1:2:3 can be obtained. Thus, there is a direct proportion between a digital value DV represented by a digital code DIC and the pulse width PW, as shown in FIG. 5B. Namely, a large digital value DV represented by a digital code DIC and larger pulse width PW.

### Fifth Embodiment

FIG. 2B is a fifth exemplary embodiment of a brightness control circuit. As shown, the brightness control circuit 100B is similar to the circuit 100A shown in FIG. 2A except that a digital code conversion unit 105 is connected between the digital code DIC and the current DAC 110. The digital code conversion unit 105 performs an inverse conversion for the digital code DIC and outputs a converted digital code DIC′ to the current DAC 110. Due to the inverse conversion of the digital code inverse conversion unit 105, there is a direct proportion between a digital value DV represented by a digital code DIC and pulse width PW, as shown in FIG. 5B. Namely, a large digital value DV represented by a digital code DIC and larger pulse width PW.

Thus, the brightness control circuits 100A˜100F can generate PWM signals with different pulse widths according to different digital codes DIC from the external timing controller (not shown). Further, the invention does not need to a latch voltage value by a sample and hold circuit for conversion to a pulse width modulated signal, and thus the invention has a higher speed and is suitable for large size and high resolution display devices. Furthermore, because the brightness control circuits 100A˜100F do not require a sample and hold circuit, incorrect pulse width modulated signals caused by charge sharing and clock feedthrough is prevented.

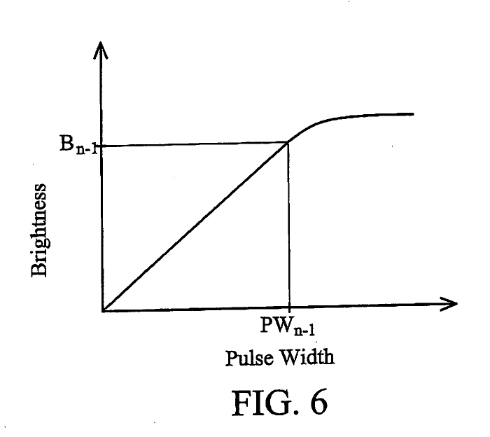

However, human eyes will produce an integration effect due to brightness generated by the time intervals. Namely, for human eyes, there is a non-linear relationship between the pulse width PW and the brightness B as shown in FIG. 6 when the pulse width is larger than PWn-1.

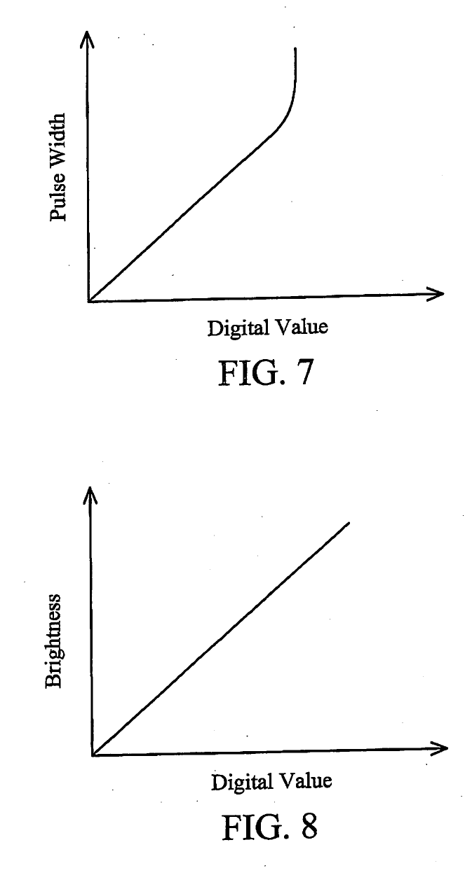

In view of this, by modifying the size of the elements, such as transistors T9˜T14 or current source I1˜I6, in the delay circuit 122, the brightness control circuit 100A˜100F can obtain an exponential relationship between the digital value DV represented by a digital code DIC and the delay time interval of the delayed clock signal DCLK by the delay circuit 122. Because pulse widths of the pulse width modulated signal are essentially equal to the corresponding delay time interval of the delayed clock signal, there is also an exponential relationship between the digital value DV represented by a digital code DIC and the pulse width of the corresponding pulse width modulated signal, as shown in FIG. 7. Due to the exponential relationship between the digital value DV represented and the pulse width, the non-linear relationship between the pulse width PW and the brightness B as shown in FIG. 6 can be compensated, such that a linear relationship between the pulse width PW and the brightness B is obtained as shown in FIG. 8. For example, the delay circuit 122 in the invention can also be replaced by a resistor-capacitor (RC) network, such that a linear relationship between the pulse width PW and the brightness B can be obtained.

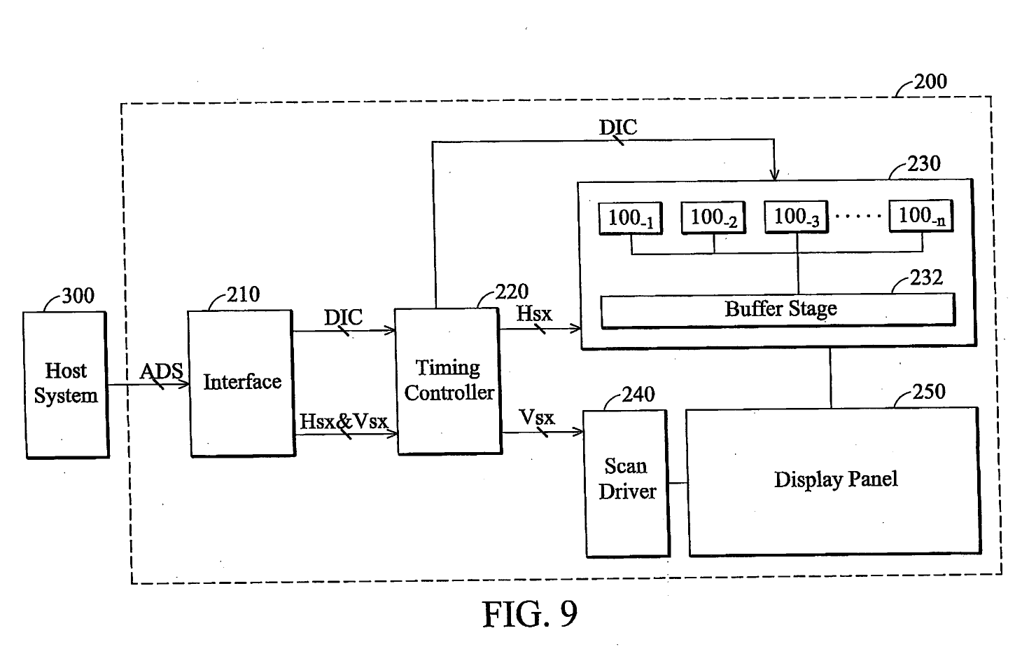

FIG. 9 is an exemplary embodiment of a display device. As shown, the display device 200 comprises an interface 210, a timing controller 220, a data driver 230, a scan driver 240 and a display panel. The interface 210 receives analog data signals, such as RGB data, horizontal scan signal HS, vertical scan signal VS and the like, from a host system 300, converts the analog data signals to digital signals, and outputs to the timing controller 220. In the invention, the interface 210 can be an analog-to-digital converter ADC, outputting digital signals comprising digital code DIC and scan signals HSX and VSX.

The timing controller 220 outputs the digital code DIC and scan signal HSX to the data driver 230 and the scan signal VSX to the scan driver 240. The data driver 230 comprises N brightness control circuits 100_1˜100_N as shown in FIGS. 2A˜2B or 3A˜3D, converting the digital code DIC from the timing controller 220 to corresponding pulse width modulated signals to output to the buffer stage 232. For example, each brightness control circuit converts a digital code of N bits to a corresponding pulse width modulated signal and outputs to the buffer stage 232. The scan driver 240 drives the display panel 250 to control brightness of pixels thereof according to the pulse width modulated signal from the buffer stage 232. The display panel can be a plasma display panel, an organic light emitting diode (OLED) display panel or the like.

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A brightness control circuit, comprising:
a current digital-to-analog converter (DAC), receiving a digital code and generating a control current; and
a one-shot circuit coupled to the current DAC, generating a pulse width modulated (PWM) signal according to the control current and a clock signal.

2. The brightness control circuit as claimed in claim 1, wherein the one-shot circuit comprises a pulse width modulator.

3. The brightness control circuit as claimed in claim 1, wherein the digital code and the pulse width modulated signal have an exponential relationship.

4. The brightness control circuit as claimed in claim 1, wherein the current DAC comprises a plurality of differential pairs connected in parallel, with input terminals of the differential pairs coupled to the digital code and generating the control current to output to the one-shot circuit.

5. The brightness control circuit as claimed in claim 2, wherein the one-shot circuit comprises:
a delay circuit coupled to the current DAC, delaying the clock signal for a predetermined time interval and outputting a delayed clock signal according to the control current; and
a logic gate unit coupled to the delay unit, generating the pulse width modulated signal according to the clock signal and the delayed clock signal.

6. The brightness control circuit as claimed in claim 5, wherein pulse width of the pulse width modulated signal is essentially equal to the predetermined time interval.

7. The brightness control circuit as claimed in claim 5, wherein the control signal and the pulse width modulated signal have an exponential relationship.

8. The brightness control circuit as claimed in claim 5, wherein the delay circuit comprises a resistor-capacitor (RC) network.

9. The brightness control circuit as claimed in claim 5, wherein the delay circuit comprises:
a first current-controlled current source comprising a first terminal coupled to a power terminal, a control terminal coupled to the control current, and a second terminal;
a delay stage comprising a first terminal coupled to the second terminal of the first current-controlled current source, a input terminal coupled to the clock signal, a second terminal and an output terminal;
a second current-controlled current source comprising a first terminal coupled to the second terminal of the delay stage, a second terminal coupled to a ground terminal, and a control terminal coupled to the control current;
a third current-controlled current source comprising a first terminal coupled to the power terminal, a control terminal coupled to the control current, and a second terminal;
a second delay stage comprising a first terminal coupled to the second terminal of the first current-controlled current source, an input terminal coupled to the output terminal of the first delay stage, an output terminal outputting the delay clock signal, and a second terminal; and
a fourth current-controlled current source comprising a first terminal coupled to the second terminal of the second delay stage, a second terminal coupled to the ground, and a control terminal coupled to the control current.

10. The brightness control circuit as claimed in claim 9, wherein the logic gate unit comprises a AND gate comprising a first input terminal coupled to the clock signal, a second input terminal coupled to the delayed clock signal, and an output terminal outputting the pulse width modulated signal.

11. The brightness control circuit as claimed in claim 9, wherein the logic gate unit further comprises a first inverter coupled between the clock signal and the first input terminal of the AND gate.

12. The brightness control circuit as claimed in claim 9, wherein the delay circuit further comprises:
a fifth current-controlled current source comprising a first terminal coupled to the power terminal, a control terminal coupled to the control current, and a second terminal;
a third delay stage comprising a first terminal coupled the second terminal of the fifth current-controlled current source, an input terminal coupled to the output terminal of the second delay stage, an output terminal outputting the delayed clock signal and a second terminal; and
a sixth current-controlled current source comprising a first terminal coupled to the second terminal of the third delay stage, a second terminal coupled to the ground terminal, and a control terminal coupled to the control current.

13. The brightness control circuit as claimed in claim 12, wherein the logic gate unit comprises a AND gate comprising a first input terminal coupled to the clock signal, a second input terminal coupled to the delayed clock signal from the third delay stage, and an output terminal outputting the pulse width modulated signal.

14. A data driver, comprising:
a brightness control circuit as claimed in claim 1, generating the pulse width modulated signal according to the digital code; and
an output buffer coupled to the brightness control circuit, receiving the pulse width modulated signal.

15. A display device, comprising:
a display panel comprising a plurality of pixels;
an interface unit, converting an analog data signal from a host system to the digital code; and
a data driver as claimed in claim 14, generating the pulse width modulated signal to control the pixels of the display panel according to the digital code.

16. The display device as claimed in claim 15, wherein the display panel comprises an active matrix LCD display panel.

17. The display device as claimed in claim 15, wherein the interface unit comprises an analog-to-digital converter.

18. The display device as claimed in claim 15, wherein the display panel comprises a plasma display panel.

19. The display device as claimed in claim 15, wherein the display panel comprises an organic light emitting diode (OLED) display panel.
